(19) United States
(12) Patent Application Publication
(10) Pub. No.: US 2026/0061575 A1
(43) Pub. Date: Mar. 5, 2026

(54) Guardrail Hardware Removal Tool

(71) Applicant: Allrail Inc., Rutherfordton, NC (US)

(72) Inventor: Tom Calton, Rutherfordton, NC (US)

(73) Assignee: Allrail Inc., Rutherfordton, NC (US)

(21) Appl. No.: 19/315,605

(22) Filed: Aug. 31, 2025

Related U.S. Application Data
(60) Provisional application No. 63/690,366, filed on Sep. 4, 2024.
(60) Provisional application No. 63/765,327, filed on Feb. 28, 2025.

(51) Int. Cl. B25B 23/00; B25B 23/10

(52) U.S. Cl. CPC B25B 23/0085; B25B 23/10

(57) ABSTRACT

A guardrail hardware removal tool is provided, comprising: a frame having a fixed jaws configured to engage a guardrail beam, the fixed jaws including an upper hook and a lower hook configured to secure to edges of the guardrail beam; movable jaws carried by the frame and positioned to move relative to the fixed jaws; contact pads carried by the movable jaws and configured to engage guardrail hardware extending from the guardrail beam; and a tension mechanism operatively connected to the movable jaws and configured to control positioning of the movable jaws relative to the fixed jaws, wherein the contact pads apply pressure to the guardrail hardware to prevent rotation during hardware removal operations.

### RELATED APPLICATIONS

This application claims priority to U.S. Provisional Patent Applications 63/690,366 filed Sep. 4, 2024 and 63/765,327 filed Mar. 4, 2025, incorporated by reference.

### BACKGROUND OF THE INVENTION

### 1) Field of Invention

This tool is a guardrail hardware removal device for facilitating the removal of bolts, including seized bolts, from roadside guardrail assemblies.

### 2) Description of the Related Art

Highway guardrail systems represent a fundamental component of roadside safety infrastructure, designed to redirect errant vehicles and minimize the severity of roadway departures. These systems typically employ W-beam guardrail panels constructed from galvanized steel and formed into a characteristic corrugated profile that provides structural strength while maintaining flexibility during impact events. The guardrail panels are interconnected through splice connections that utilize multiple bolt and nut combinations, typically eight fasteners per splice joint, to create continuous barrier systems along roadway corridors. Each guardrail panel is also secured to supporting posts through additional bolt connections that transfer loads from the guardrail structure to the foundation elements.

The maintenance and replacement of guardrail systems presents considerable challenges, particularly in geographic regions where environmental conditions contribute to the corrosion and seizure of hardware components. In northern climates and areas where deicing chemicals are applied to roadway surfaces, guardrail hardware becomes exposed to corrosive substances that penetrate the galvanized coatings and cause the bolt and nut combinations to seize over time. This corrosion process is accelerated by the repeated application of salt-based deicing compounds that are displaced from the roadway surface onto adjacent guardrail installations through snow removal operations and natural precipitation patterns. The resulting chemical exposure creates conditions where standard hand tools and conventional removal techniques become ineffective for disassembling guardrail connections.

Current approaches to removing seized guardrail hardware often rely on destructive methods that compromise the reusability of the guardrail materials and create safety hazards for maintenance personnel. These methods typically involve cutting operations using power saws or torches that generate high temperatures, flying debris, and fire risks while rendering the guardrail panels unsuitable for reinstallation or secondary applications. The destructive removal processes also increase labor costs, extend project timelines, and reduce the sustainable value recovery from existing guardrail installations. Additionally, the physical demands of manual hardware removal operations expose workers to ergonomic stresses and injury risks associated with applying high torque loads to seized fasteners while maintaining awkward working positions adjacent to active roadways.

It is an object of the present guardrail hardware removal tool to provide a specialized clamping mechanism that secures directly to guardrail structures and prevents bolt rotation during nut removal operations, enabling the use of standard tools for hardware removal without requiring destructive cutting methods.

It is another object of the present guardrail hardware removal tool to provide adjustable contact elements that accommodate variations in guardrail geometry and hardware positioning while maintaining consistent pressure distribution across multiple contact points on the guardrail structure.

It is another object of the present guardrail hardware removal tool to provide a portable and manually operated system that eliminates the need for powered equipment or specialized lifting devices during guardrail maintenance operations.

It is another object of the present guardrail hardware removal tool to provide enhanced safety for maintenance personnel by eliminating the need for manual stabilization of hardware components and reducing exposure to hazards associated with cutting operations and flying debris.

### BRIEF SUMMARY OF THE INVENTION

The above objectives are accomplished by providing a guardrail hardware removal tool comprising a frame having fixed jaws configured to engage a guardrail beam, the fixed jaws including an upper hook and a lower hook configured to secure to edges of the guardrail beam, movable jaws carried by the frame and positioned to move relative to the fixed jaws, contact pads carried by the movable jaws and configured to engage guardrail hardware extending from the guardrail beam, and a tension mechanism operatively connected to the movable jaws and configured to control positioning of the movable jaws relative to the fixed jaws, wherein the contact pads apply pressure to the guardrail hardware to prevent rotation during hardware removal operations.

The frame may comprise steel plates arranged to accept a W-shape guardrail beam, wherein each steel plate makes contact with the surface of the W-shape guardrail beam. The movable jaws may comprise a first movable jaw and a second movable jaw and may further include a jaw tension cross bar extending between the first movable jaw and the second movable jaw to coordinate movement of the movable jaws. The tension mechanism may comprise a tension bar head connected to the jaw tension cross bar and a tension bar extending through the tension bar head, wherein rotation of the tension bar controls positioning of the movable jaws. The tension bar head may comprise a shaped interface configured for engagement with a tool selected from the group consisting of wrenches, socket drivers, and screwdrivers.

The contact pads may comprise upper contact pads and lower contact pads positioned to engage with splice bolts extending from the guardrail beam and may further include contact jaw pivots connecting the contact pads to the movable jaws to allow the contact pads to adjust orientation when engaging the guardrail beam. The movable jaws may be guided by movable jaw bars extending through movable jaw slots formed in the movable jaws, the movable jaw bars and movable jaw slots defining a controlled path for movement of the movable jaws relative to the fixed jaws.

The system may also be configured as a guardrail bolt stabilization apparatus facilitating guardrail removal comprising a clamping frame configured to mount on a W-shaped guardrail beam, a plurality of contact elements carried by the clamping frame and positioned to engage multiple surfaces of the W-shaped guardrail beam, an adjustment mechanism operatively connected to the contact elements and configured to control engagement force applied by the contact elements to guardrail bolts, and hook elements extending from the clamping frame and configured to secure the apparatus to the guardrail beam during operation.

The clamping frame may comprise fixed jaws connected by cross bars, wherein the fixed jaws are configured to provide structural support for the contact elements during operation. The hook elements may comprise an upper hook and a lower hook extending from the fixed jaws, the upper hook configured to engage an upper edge of the W-shaped guardrail beam and the lower hook configured to engage a lower edge of the W-shaped guardrail beam. The plurality of contact elements may comprise upper contact pads and lower contact pads positioned to engage splice bolts extending from the W-shaped guardrail beam and may further include contact jaw pivots connecting the contact elements to the clamping frame to allow the contact elements to adjust orientation when engaging the guardrail beam.

The contact elements may be carried by movable jaw assemblies that are guided by movable jaw bars extending through movable jaw slots, the movable jaw bars and movable jaw slots defining a controlled path for movement of the contact elements relative to the clamping frame. The adjustment mechanism may comprise a tension bar extending through a tension bar head, wherein rotation of the tension bar controls engagement force applied by the contact elements to the guardrail bolts. The tension bar head may comprise a shaped interface selected from the group consisting of hexagonal, square, slotted, cross-slotted, starred, and keyed configurations for engagement with corresponding tools.

The apparatus may alternatively be configured for removing seized guardrail hardware comprising a structural framework including a fixed jaw assembly and a movable jaw assembly, attachment hooks carried by the structural framework and configured to engage upper and lower edges of a guardrail structure, pressure-applying elements positioned between the first jaw assembly and the second jaw assembly and configured to contact bolt heads extending from the guardrail structure, and an actuating system configured to move the pressure-applying elements toward the guardrail structure to immobilize the bolt heads while allowing access to corresponding nuts on an opposite side of the guardrail structure.

The structural framework may include cross bars connecting a plurality of fixed jaws, wherein the second jaw assembly is a movable jaw assembly positioned to move relative to the fixed jaw assembly. The attachment hooks may comprise an upper hook and a lower hook extending from the fixed jaws, the upper hook configured to engage an upper edge of the guardrail structure and the lower hook configured to engage a lower edge of the guardrail structure. The pressure-applying elements may comprise contact pads configured to engage splice bolts extending from the guardrail structure and may further include pivot connections connecting the contact pads to the first jaw assembly and the second jaw assembly to allow the contact pads to adjust orientation when engaging the guardrail structure.

The first jaw assembly or the second jaw assembly may be guided by guide bars extending through guide slots formed in the first jaw assembly or the second jaw assembly, the guide bars and guide slots defining a controlled path for movement of the pressure-applying elements relative to the structural framework. The actuating system may comprise a threaded adjustment mechanism including a tension bar extending through a tension bar head, wherein rotation of the tension bar controls movement of the second jaw assembly along the controlled path defined by the guide bars and guide slots.

### BRIEF DESCRIPTION OF SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a perspective view of aspects of the guardrail hardware removal tool;

FIG. 2 is a perspective view of aspects of the guardrail hardware removal tool mounted on a guardrail beam;

FIG. 3 is a perspective view of aspects of the guardrail hardware removal tool;

FIG. 4 is a front view of aspects of the guardrail hardware removal tool;

FIG. 5 is an exploded perspective view of aspects of the guardrail hardware removal tool;

FIG. 6 is an exploded view of a movable jaw configuration of aspects of the guardrail hardware removal tool; and,

FIG. 7 is a perspective view of aspects of the guardrail hardware removal tool.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

With reference to the drawings, the invention will now be described in more detail.

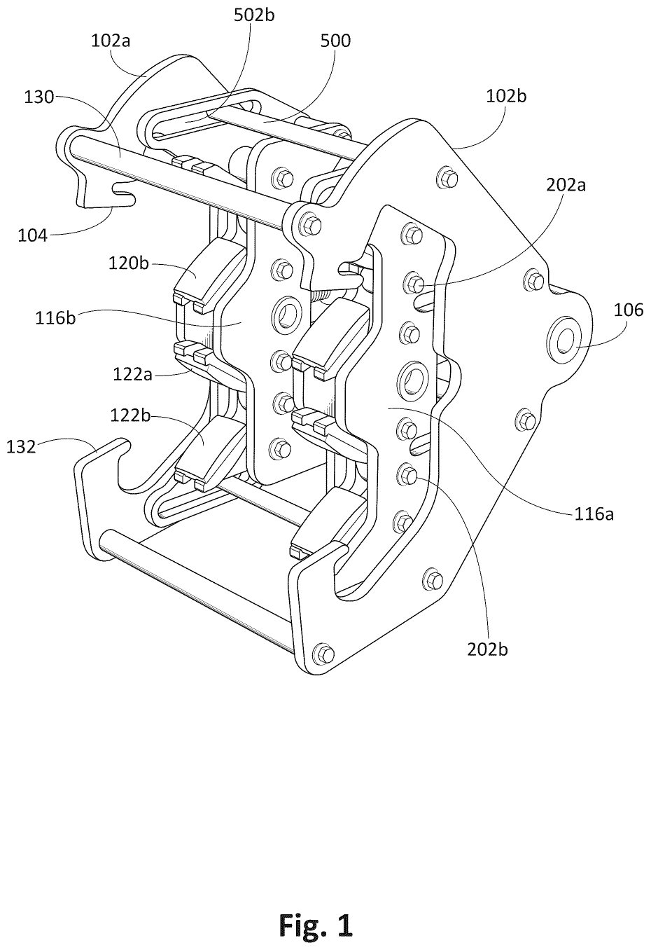

Referring to FIG. 1, a guardrail hardware removal tool is shown in perspective view. The tool includes a frame structure designed to engage with and secure to a guardrail beam during hardware removal operations. The frame includes fixed jaws 102a and 102b that provide the primary structural foundation for the tool. The fixed jaws 102a and 102b are connected by an upper cross bar 130 that maintains the structural integrity and spacing between the fixed jaws 102a and 102b. The frame structure is comprised of steel plates arranged to accept a w-shape guardrail beam wherein each steel plate makes contact with a surface of the w-shape guardrail beam, allowing the tool to conform to the specific geometry of standard highway guardrail installations.

The tool incorporates an upper hook 104 and a lower hook 132 that extend from the fixed jaws 102a and 102b to engage the edges of the guardrail beam. The upper hook 104 and lower hook 132 function as primary attachment points that secure the tool to the guardrail structure during operation. In one embodiment, alignment hooks are used to assist with aligning the tool on the w-shape beam prior to engaging components used to tighten the hooks on the guardrail beam. The upper hook 104 and lower hook 132 work in conjunction with other components to create a secure clamping mechanism that prevents the tool from shifting or becoming dislodged during hardware removal procedures.

The tool includes movable jaws 116a and 116b that are carried within the frame structure formed by the fixed jaws 102a and 102b. The movable jaws 116a and 116b provide adjustable positioning capabilities that allow the tool to accommodate variations in guardrail dimensions and hardware configurations. A movable jaw pivot 106 connects the movable jaws 116a and 116b to the frame structure, enabling the movable jaws 116a and 116b to articulate relative to the fixed jaws 102a and 102b. The movable jaw pivot 106 allows the tool to adapt to slight variations in guardrail geometry and ensures proper contact between the tool components and the guardrail surface.

Contact elements are integrated into the movable jaw structure to engage with guardrail hardware during removal operations. Upper contact pads 122a and lower contact pads 120b and 122b are positioned on the movable jaws 116a and 116b to make direct contact with splice bolts and other hardware components. The upper contact pads 122a and lower contact pads 120b and 122b are connected to the movable jaw structure through contact jaw pivots 202a and 202b that allow the contact pads to adjust their orientation relative to the guardrail surface. In one configuration, one or more rubber spacers can be used to position the tool on the guardrail, providing cushioning and ensuring proper alignment between the tool components and the guardrail structure.

The movable jaw structure operates along a controlled path defined by mechanical guidance components. A movable jaw bar 500 works in conjunction with a movable jaw slot 502b to enable precise movement of the movable jaws 116a and 116b relative to the fixed jaws 102a and 102b. The movable jaw bar 500 extends through the movable jaw slot 502b, creating a sliding mechanism that maintains proper alignment while allowing the movable jaws 116a and 116b to advance toward or retract from the guardrail surface. This sliding mechanism ensures that the contact pads maintain consistent pressure against the guardrail hardware while preventing lateral movement that could compromise the tool's effectiveness during hardware removal operations.

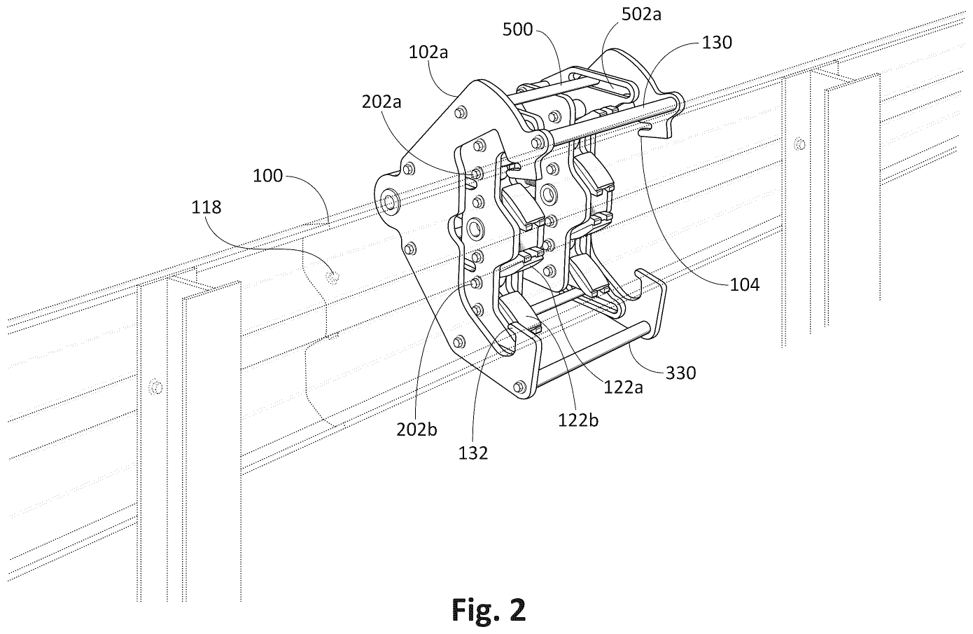

Referring to FIG. 2, the guardrail hardware removal tool is shown positioned on a guardrail beam 100 during operation. The guardrail beam 100 exhibits the characteristic W-shaped cross-section that is standard in highway guardrail installations. The fixed jaws 102a engage with the guardrail beam 100 through the upper hook 104 and the lower hook 132, which secure to the upper and lower edges of the guardrail beam 100 respectively. This engagement creates a stable mounting platform that prevents the tool from shifting during hardware removal operations. The structural connection between the fixed jaws 102a and the guardrail beam 100 is maintained through the upper cross bar 130 and a lower cross bar 330, which provide the necessary rigidity to withstand the forces generated during bolt removal procedures.

The contact pad system engages directly with a guard rail bolt 118 that extends through the guardrail beam 100. The upper contact pads 122a and the lower contact pads 122b are positioned to make contact with the guard rail bolt 118, applying pressure that prevents the guard rail bolt 118 from rotating during nut removal operations. The contact pad configuration mirrors the shape of the guardrail beam 100, with each contact pad configured to engage with a surface of the W-shaped profile. This geometric matching ensures that the contact pads distribute pressure evenly across the guard rail bolt 118 and the surrounding guardrail structure. The contact pads connect to the movable jaw configuration through contact jaw pivots 202a and 202b, which allow the contact pads to pivot when engaging the guardrail beam 100, accommodating variations in bolt positioning and guardrail geometry.

The movable jaw system operates through a controlled mechanism that positions the contact pads against the guard rail bolt 118. A movable jaw slot 502a works in conjunction with the movable jaw bar 500 to guide the movement of the contact pad assembly relative to the fixed jaws 102a. When the tool is tightened onto the guardrail beam 100, the movable jaw configuration advances along the path defined by the movable jaw slot 502a and the movable jaw bar 500, bringing the upper contact pads 122a and the lower contact pads 122b into firm contact with the guard rail bolt 118. The lower cross bar 330 provides structural support during this operation, maintaining the alignment between the contact pad system and the guardrail beam 100. The contact jaw pivots 202a and 202b enable the contact pads to adjust their orientation as the tool engages with the guardrail beam 100, ensuring optimal contact with the guard rail bolt 118 regardless of minor variations in bolt positioning or guardrail alignment.

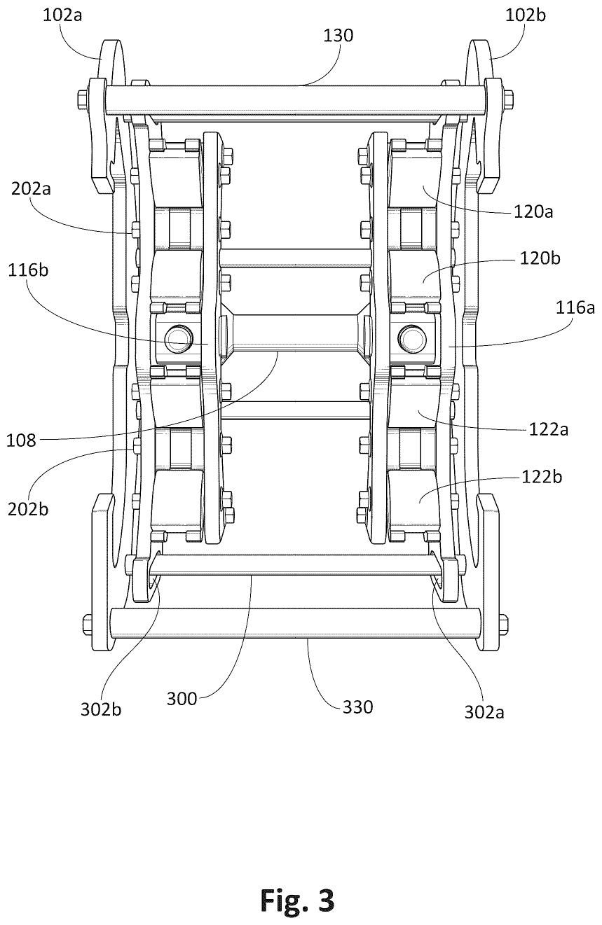

Referring to FIG. 3, the guardrail hardware removal tool is shown from an alternative perspective that illustrates the internal configuration of the movable jaw system and the relationship between movable components and the fixed jaws 102a and 102b. The fixed jaws 102a and 102b are connected by the upper cross bar 130 and a lower cross bar 330, which maintain the structural framework of the tool. A jaw tension cross bar 108 extends between the movable jaw components, providing a mechanical connection that coordinates the movement of the movable jaw system during operation. The jaw tension cross bar 108 functions as a primary structural element that transfers force between opposing movable jaw assemblies, ensuring synchronized movement when the tool is engaged with a guardrail structure.

The movable jaw system includes movable jaws 116a and 116b that are positioned internal to the fixed jaws 102a and 102b. The movable jaws 116a and 116b carry contact pad assemblies that engage with guardrail hardware during removal operations. Upper contact pads 120a and 122a are positioned on the movable jaws 116a and 116b to contact the upper surfaces of the guardrail structure, while the lower contact pads 120b and 122b engage with the lower surfaces. The contact pad configuration creates a comprehensive engagement system that distributes pressure across multiple contact points on the guardrail beam. The upper contact pads 120a and 122a work in coordination with the lower contact pads 120b and 122b to stabilize guardrail hardware and prevent rotation during bolt removal procedures.

The movable jaw assemblies operate along controlled paths defined by mechanical guidance systems integrated into the tool structure. A movable jaw bar 300 extends through the frame structure and engages with movable jaw slots 302a and 302b that are formed in the movable jaw assemblies. The movable jaw bar 300 provides a linear guide that constrains the movement of the movable jaws 116a and 116b to a predetermined path relative to the fixed jaws 102a and 102b. The movable jaw slots 302a and 302b accommodate the movable jaw bar 300 while allowing the movable jaw assemblies to slide along the length of the movable jaw bar 300. This sliding mechanism enables precise positioning of the contact pad assemblies relative to the guardrail structure while maintaining proper alignment throughout the range of motion.

The contact pad system incorporates pivoting mechanisms that allow individual contact elements to adjust their orientation when engaging with guardrail surfaces. Contact jaw pivots 202a and 202b connect the contact pad assemblies to the movable jaw structure, enabling the upper contact pads 120a and 122a and the lower contact pads 120b and 122b to pivot independently. The contact jaw pivots 202a and 202b accommodate variations in guardrail geometry and hardware positioning, ensuring that each contact pad maintains optimal contact with the guardrail surface regardless of minor dimensional variations. In one embodiment, each movable jaw configuration carries two contact units, with each contact unit including a contact pad jaw spacer and two contact pad jaws that position the contact pads relative to the guardrail surfaces.

In one configuration, the movable jaw system is designed to accommodate different guardrail profiles beyond the standard W-beam configuration. Alternative configurations engage other shapes of guardrail structures by adjusting the spacing and orientation of the contact pad assemblies. The modular design of the contact pad system allows for reconfiguration of the upper contact pads 120a and 122a and the lower contact pads 120b and 122b to match the specific geometry of different guardrail types. The jaw tension cross bar 108 and the movable jaw bar 300 provide the structural foundation for these alternative configurations, while the movable jaw slots 302a and 302b accommodate the adjusted positioning requirements for different guardrail profiles.

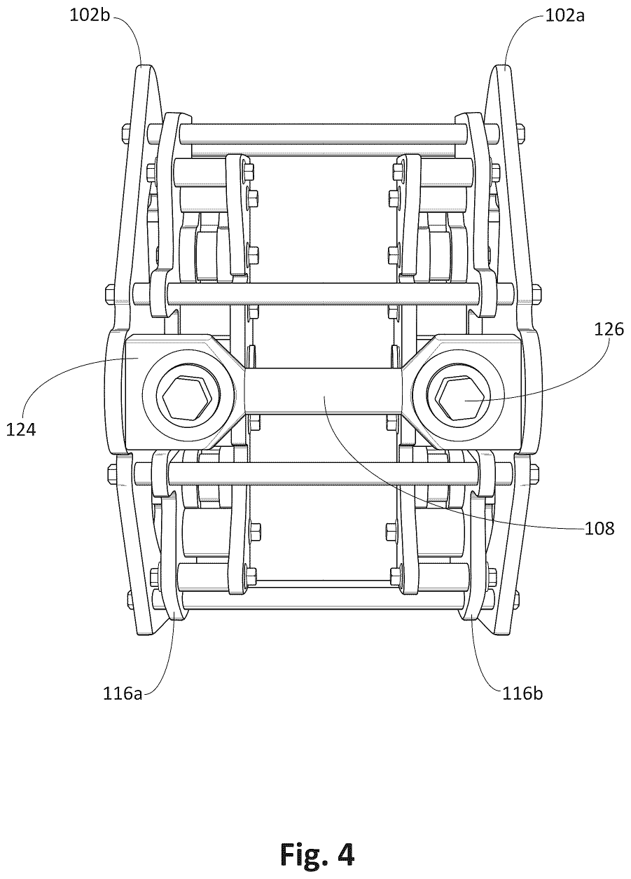

Referring to FIG. 4, the guardrail hardware removal tool is shown from a front view that illustrates the tension mechanism configuration used to control the positioning of the movable jaw assemblies. The fixed jaws 102a and 102b are positioned on opposite sides of the tool structure, providing the primary framework that supports the movable components during operation. The movable jaws 116a and 116b are positioned internal to the fixed jaws 102a and 102b, creating a nested configuration that allows the movable jaw assemblies to advance toward or retract from a guardrail structure while maintaining proper alignment with the fixed jaw framework. A jaw tension cross bar 108 extends between the movable jaws 116a and 116b, providing a mechanical connection that coordinates the movement of the opposing movable jaw assemblies and ensures synchronized operation during tool engagement.

The tension mechanism includes a tension bar head 124 that connects to the movable jaw system and provides the primary interface for adjusting the position of the movable jaw assemblies relative to the fixed jaws 102a and 102b. The tension bar head 124 functions as a mechanical actuator that transfers rotational input from an operator into linear motion of the movable jaw assemblies. A tension bar 126 extends through the tension bar head 124, creating a threaded connection that converts rotational motion into controlled linear displacement of the movable jaw components. The tension bar 126 engages with the jaw tension cross bar 108 through a mechanical interface that allows the tension bar 126 to advance or retract the movable jaws 116a and 116b along their designated travel paths.

In one embodiment, the tension bar head 124 includes a shaped interface that facilitates engagement with standard tools for rotating the tension bar 126. The tension bar head 124 can be shaped as hexagonal, square, slotted, cross-slotted, starred, keyed, or other common bolt or screw head shapes that allow for easy engagement with corresponding tools such as wrenches, socket drivers, or screwdrivers. The shaped interface of the tension bar head 124 provides multiple engagement options that accommodate different tool preferences and working conditions encountered during guardrail hardware removal operations. The tension bar head 124 transfers rotational force applied by an operator through the tension bar 126 to the jaw tension cross bar 108, which distributes the force to both movable jaws 116a and 116b simultaneously.

In one configuration, the tension mechanism includes a tightening mechanism positioned at the end of the tension bar 126 that provides additional interface options for tool engagement. The tightening mechanism can be shaped like a nut, a wing nut, a gear, or any other shape designed to allow easy engagement to rotate the tension bar 126. The tightening mechanism functions as an alternative or supplementary interface to the tension bar head 124, providing operators with multiple options for applying rotational force to the tension mechanism. Wing nut configurations allow for hand operation without additional tools, while nut configurations accommodate standard wrench engagement, and gear configurations can interface with specialized tools for increased mechanical advantage during operation.

The operation of the tension mechanism controls the grip force applied by the tool to a guardrail structure during hardware removal procedures. When the tension bar 126 is rotated in a tightening direction, the tension bar head 124 advances the jaw tension cross bar 108, which draws the movable jaws 116a and 116b toward each other and increases the contact pressure between the contact pad assemblies and the guardrail hardware. The controlled advancement of the movable jaws 116a and 116b through the tension mechanism ensures that the contact pads maintain consistent pressure against guardrail bolts while preventing over-tightening that could damage the guardrail structure or the tool components. Conversely, rotating the tension bar 126 in a loosening direction retracts the movable jaws 116a and 116b, reducing contact pressure and allowing for tool removal from the guardrail structure.

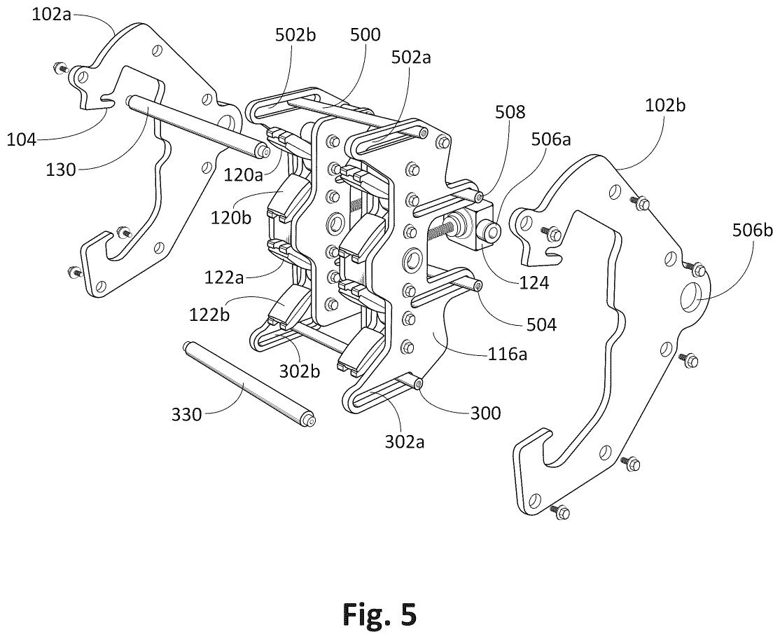

Referring to FIG. 5, the guardrail hardware removal tool is shown in an exploded perspective view that illustrates the individual components and their assembly relationships within the complete tool structure. The exploded view demonstrates how the various mechanical elements connect together to form the functional hardware removal system. The fixed jaws 102a and 102b form the primary structural framework and are connected by the upper cross bar 130 and the lower cross bar 330, which maintain the dimensional stability and alignment of the tool during operation. The upper hook 104 extends from the fixed jaw structure to engage with the upper edge of a guardrail beam, while the structural connections between the fixed jaws 102a and 102b provide the foundation for supporting the movable components during hardware removal procedures.

The movable jaw 116a is positioned between the fixed jaws 102a and 102b and carries the contact pad assemblies that engage directly with guardrail hardware during operation. The upper contact pads 120a and 122a are mounted on the movable jaw 116a to contact the upper surfaces of the guardrail structure, while the lower contact pads 120b and 122b engage with the lower surfaces of the guardrail beam. The contact pad configuration creates multiple contact points that distribute pressure across the guardrail hardware and prevent rotation of splice bolts during removal operations. The tension bar head 124 connects to the movable jaw assembly and provides the mechanical interface for controlling the position of the movable jaw 116a relative to the fixed jaws 102a and 102b through the operation of threaded adjustment mechanisms.

The movable jaw assembly operates along controlled paths defined by multiple movable jaw bars that extend through the frame structure and engage with corresponding slots in the movable jaw components. A movable jaw bar 300 extends through the frame and engages with the movable jaw slots 302a and 302b that are formed in the movable jaw 116a. The movable jaw bar 500 provides an additional guidance path that works in conjunction with the movable jaw slots 502a and 502b to constrain the movement of the movable jaw 116a to a predetermined linear path relative to the fixed jaws 102a and 102b. A movable jaw bar 504 and a movable jaw bar 508 provide additional structural support and guidance for the movable jaw assembly, creating a comprehensive guidance system that maintains proper alignment throughout the range of motion while preventing lateral displacement that could compromise the effectiveness of the contact pad engagement with guardrail hardware.

The pivot mechanism that connects the movable jaw assembly to the frame structure includes a movable jaw pivot post 506a and a movable jaw pivot receptacle 506b that form the mechanical connection between the movable components and the fixed jaw framework. The movable jaw pivot post 506a extends from the tension bar head 124 and engages with the movable jaw pivot receptacle 506b that is formed in the fixed jaw structure, creating a pivoting connection that allows the movable jaw 116a to articulate relative to the fixed jaws 102a and 102b. The pivot mechanism accommodates variations in guardrail geometry and ensures that the contact pad assemblies maintain optimal contact with the guardrail surface regardless of minor dimensional variations in the guardrail installation. The movable jaw pivot post 506a and the movable jaw pivot receptacle 506b are constructed from durable materials that withstand the mechanical stresses generated during tool operation while providing smooth articulation throughout the range of pivot motion.

In one embodiment, the structural components of the tool include materials selected for durability and controlled flexibility during operation. The locking bar components are constructed from semi-flexible or compressible material such as aluminum or softer steel that provides the necessary strength for hardware removal operations while allowing controlled deformation that accommodates variations in guardrail dimensions and hardware positioning. The semi-flexible construction of the locking bar elements enables the tool to conform to slight irregularities in the guardrail structure while maintaining consistent contact pressure across the contact pad assemblies. The aluminum or softer steel construction provides corrosion resistance and weight reduction compared to harder steel alternatives while maintaining the structural integrity required for repeated use in demanding field conditions.

In one configuration, the hook assemblies incorporate replaceable components that facilitate field maintenance and adjustment of the tool. The hook elements are carried by a stirrup connected through a threaded rod that allows for easy replacement of a broken hook and allows for slight adjustments in the height of the hook relative to the frame structure. The threaded rod connection provides a mechanical interface that enables field personnel to remove and replace damaged hook components without requiring specialized tools or extensive disassembly of the complete tool. The stirrup and threaded rod assembly also enables height adjustment of the hook components to accommodate different guardrail configurations or to compensate for wear in the hook surfaces that occurs during extended use. The threaded connection provides precise adjustment capability while maintaining secure attachment of the hook components to the frame structure during operation.

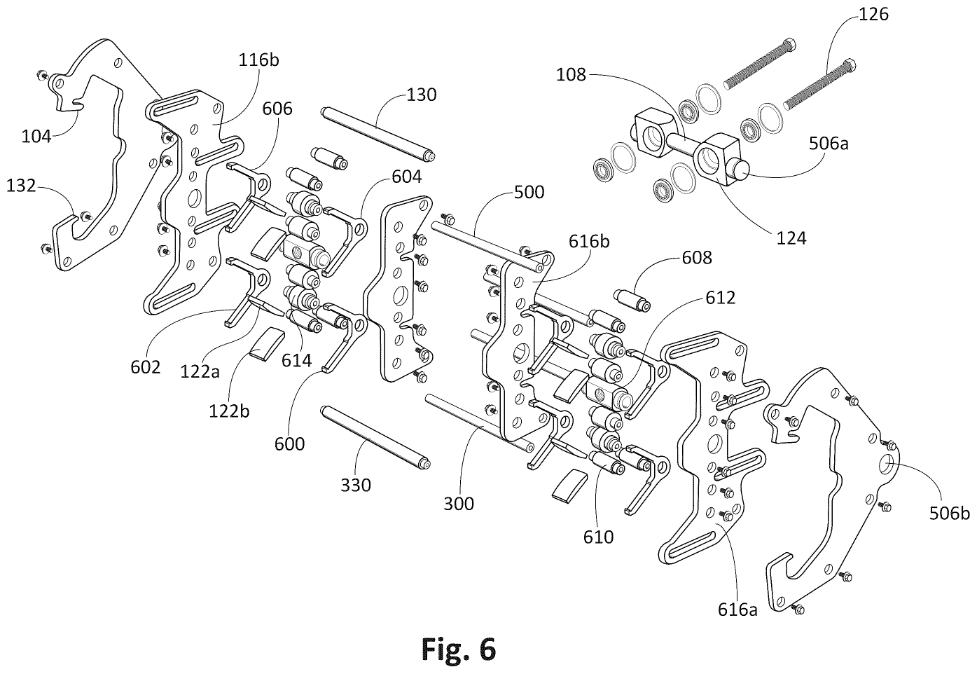

Referring to FIG. 6, the movable jaw configuration includes a detailed assembly of components that work together to create a functional jaw system for engaging with guardrail hardware. The movable jaw configuration includes a Movable Jaw Outside Plate 616a and a Movable Jaw Inside Plate 616b that form the primary structural elements of the jaw assembly. The Movable Jaw Outside Plate 616a and the Movable Jaw Inside Plate 616b are positioned parallel to each other and are held in a fixed spatial relationship by structural spacer elements that maintain the proper dimensional spacing between the plates during operation. A movable jaw spacer 608 and a movable jaw spacer 610 extend between the Movable Jaw Outside Plate 616a and the Movable Jaw Inside Plate 616b, creating a rigid framework that maintains the structural integrity of the jaw assembly while allowing the assembly to move as a unified component relative to the fixed jaws.

The contact pad system within the movable jaw configuration includes multiple contact pad jaw elements that position and support the contact elements used to engage with guardrail hardware. A Contact Pad Jaw 600, a Contact Pad Jaw 602, a Contact Pad Jaw 604, and a Contact Pad Jaw 606 are integrated into the movable jaw configuration to provide multiple contact points for engaging with the surfaces of a guardrail beam. The Contact Pad Jaw 600 and the Contact Pad Jaw 602 work together to support the upper contact pads 122a, while the Contact Pad Jaw 604 and the Contact Pad Jaw 606 support the lower contact pads 122b. A contact Pad Jaw spacer 614 is positioned between adjacent contact pad jaw elements to maintain proper spacing and alignment between the Contact Pad Jaw 600, the Contact Pad Jaw 602, the Contact Pad Jaw 604, and the Contact Pad Jaw 606. The contact Pad Jaw spacer 614 ensures that each contact pad jaw element maintains its designated position within the movable jaw configuration while allowing the contact pad assemblies to function independently when engaging with guardrail surfaces.

The movable jaw configuration incorporates pivot mechanisms that enable the contact pad assemblies to adjust their orientation when engaging with guardrail structures. A tension bar pivot 612 connects the movable jaw configuration to the tension bar 126, creating a mechanical interface that allows the tension bar 126 to control the position of the movable jaw configuration relative to the fixed jaws. The tension bar pivot 612 enables the movable jaw configuration to articulate relative to the tension bar 126 while maintaining a secure mechanical connection that transfers force from the tension bar 126 to the movable jaw configuration. The tension bar pivot 612 accommodates angular adjustments that occur when the movable jaw configuration engages with guardrail surfaces that exhibit variations in geometry or positioning relative to the tool framework.

In one embodiment, the movable jaw configuration includes adjustment mechanisms that enhance the engagement between the contact pad assemblies and guardrail hardware. Steel shim pads can be used to fine tune the configuration to better enhance engagement between the contact pad jaw elements and the guardrail surfaces. The steel shim pads provide precise dimensional adjustments that compensate for variations in guardrail thickness, hardware positioning, or manufacturing tolerances that affect the contact between the upper contact pads 122a and the lower contact pads 122b and the guardrail structure. The steel shim pads can be positioned between the contact pad jaw elements and the contact surfaces to optimize the pressure distribution and contact area between the tool components and the guardrail hardware during removal operations.

In one configuration, the tension mechanism includes safety features that prevent over-tightening or excessive loosening of the movable jaw configuration during operation. A safety stop prevents the torque rod from being over tightened or loosened by engaging stop points on the tool that limit the range of motion of the tension adjustment mechanism. The safety stop functions as a mechanical limit that prevents the tension bar 126 from advancing or retracting beyond predetermined positions that could damage the tool components or compromise the effectiveness of the guardrail engagement. Stop points can be simple peg protrusions from the tool which the safety stop engages and is thereby prevented from further rotation beyond the safe operating range. The stop points provide positive mechanical engagement with the safety stop, creating definitive limits that prevent operator error from causing damage to the movable jaw configuration or the guardrail structure during hardware removal procedures.

In one example, the tension mechanism operates through mechanical components that provide smooth and controlled movement of the movable jaw configuration. The torquing rod can operate on one or more steel ball-bearing rollers that reduce friction and enable precise control of the jaw positioning during engagement with guardrail hardware. The steel ball-bearing rollers support the torquing rod and allow the rod to rotate smoothly while transferring force to the movable jaw configuration through the tension bar pivot 612. The steel ball-bearing rollers distribute the mechanical loads generated during tool operation and reduce wear on the torquing rod and the supporting structure, extending the operational life of the tool while maintaining consistent performance during repeated use in field conditions.

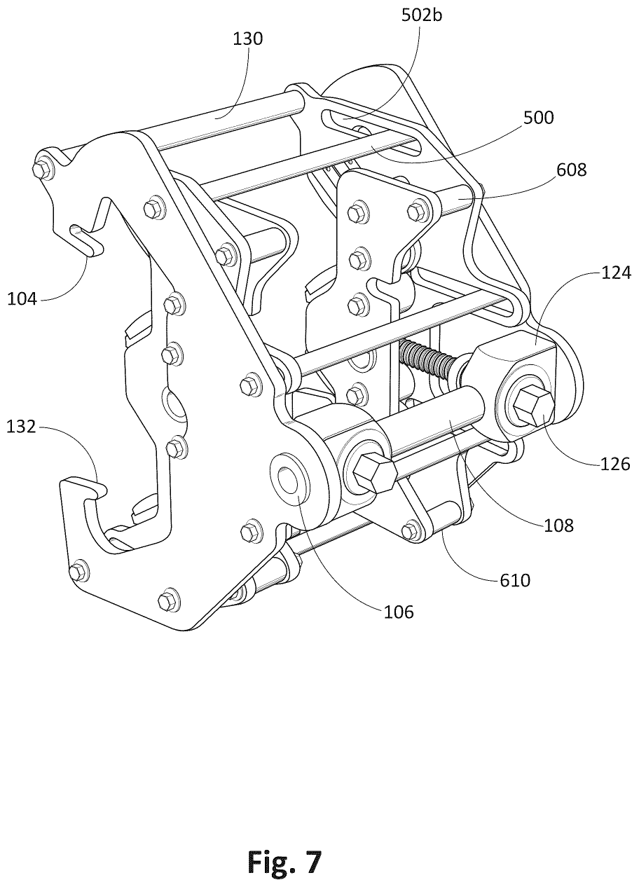

Referring to FIG. 7, the guardrail hardware removal tool is shown in a final assembled perspective that demonstrates the complete integration of all structural and mechanical components into a unified hardware removal system. The assembled tool presents a robust and functional configuration that incorporates all the individual elements described in the previous figures into a cohesive unit designed for field deployment in guardrail maintenance operations. The perspective view illustrates how the various mechanical systems work together to create a tool that can effectively engage with guardrail structures and provide the necessary force and stability required for hardware removal procedures. The overall appearance of the assembled tool reflects a balance between structural strength and operational functionality, with each component positioned to contribute to the overall effectiveness of the hardware removal process.

The structural framework of the assembled tool demonstrates the integration of the fixed jaw components with the movable jaw assemblies to create a comprehensive clamping system. The fixed jaw elements provide the primary structural foundation that supports the movable components during operation, while the movable jaw assemblies incorporate the contact pad systems and adjustment mechanisms that enable the tool to engage with guardrail hardware. The connection between the fixed and movable components creates a mechanical system that can accommodate variations in guardrail dimensions while maintaining consistent contact pressure across the hardware engagement surfaces. The assembled configuration shows how the individual components described in the exploded views come together to form a functional tool that can be deployed in field conditions for guardrail maintenance operations.

The tension mechanism components are fully integrated into the assembled tool structure, creating a control system that enables operators to adjust the engagement force and positioning of the contact pad assemblies relative to the guardrail structure. The tension adjustment components extend through the tool framework and connect to the movable jaw assemblies through mechanical interfaces that transfer rotational input from the operator into controlled linear motion of the contact elements. The assembled tension mechanism demonstrates how the individual adjustment components work together to provide precise control over the tool engagement while maintaining the structural integrity necessary for effective hardware removal operations. The integration of the tension mechanism into the overall tool structure creates a unified system that combines structural strength with operational flexibility.

In one configuration, the assembled tool incorporates safety features and operational enhancements that improve the effectiveness and reliability of the hardware removal process. The complete assembly includes mechanical stops and limiting devices that prevent over-adjustment of the tension mechanism and protect both the tool components and the guardrail structure from damage during operation. The assembled tool also incorporates ergonomic features that facilitate operator interaction with the adjustment mechanisms and enable efficient deployment of the tool in field conditions. The overall design of the assembled tool reflects consideration of the operational environment and the need for reliable performance under the demanding conditions encountered during guardrail maintenance operations.

The finished appearance of the guardrail hardware removal tool demonstrates a professional-grade construction that reflects the engineering requirements for effective guardrail hardware removal. The assembled tool exhibits a compact and portable configuration that facilitates transportation to work sites while providing the structural strength necessary for engaging with seized or corroded guardrail hardware. The surface finishes and material selections visible in the assembled tool reflect consideration of the corrosive environment in which the tool operates, with protective coatings and corrosion-resistant materials incorporated where appropriate to extend the operational life of the tool. The overall aesthetic of the assembled tool conveys the functional nature of the device while maintaining the professional appearance expected of specialized maintenance equipment used in highway infrastructure applications.

The guardrail hardware removal tool provides several advantages over conventional hardware removal methods and existing tools used in guardrail maintenance operations. Traditional approaches to guardrail hardware removal typically rely on standard wrenches, socket sets, or impact tools that may not provide adequate leverage or stability when dealing with seized or corroded bolts in roadside environments. The specialized design of this tool addresses the unique challenges encountered in guardrail maintenance by providing a dedicated clamping system that secures directly to the guardrail structure, eliminating the need for operators to manually stabilize hardware during removal procedures.

The integrated clamping mechanism offers significant advantages over prior art approaches that require separate tools or manual holding techniques to prevent bolt rotation during nut removal. The fixed jaw system with upper hook 104 and lower hook 132 creates a secure attachment to the guardrail beam that remains stable throughout the hardware removal process, reducing the physical effort required from operators and improving safety by eliminating the need to manually grip or stabilize moving components. The contact pad system distributes clamping force across multiple contact points on the guardrail hardware, providing more effective grip than single-point contact tools while reducing the risk of damage to the guardrail structure.

The adjustable tension mechanism provides precise control over the clamping force applied to guardrail hardware, allowing operators to optimize the grip for different bolt conditions and guardrail configurations. This adjustability represents an improvement over fixed-geometry tools that may not accommodate variations in hardware dimensions or may apply excessive force that damages the guardrail structure. The tension bar 126 and tension bar head 124 enable operators to fine-tune the engagement pressure, providing sufficient force to prevent bolt rotation while avoiding over-tightening that could deform the guardrail beam or damage the tool components.

The modular contact pad configuration allows the tool to accommodate different guardrail profiles and hardware arrangements, providing versatility that may not be available in specialized tools designed for specific guardrail types. The pivoting contact pad assemblies connected through contact jaw pivots 202a and 202b enable the tool to conform to variations in guardrail geometry and hardware positioning, maintaining effective engagement even when guardrail installations exhibit dimensional variations or alignment irregularities. This adaptability reduces the need for multiple specialized tools and enables a single device to handle a broader range of guardrail maintenance scenarios.

The structural design of the tool provides enhanced leverage and mechanical advantage compared to handheld tools, enabling operators to remove seized or corroded hardware that may be difficult or impossible to address with conventional approaches. The rigid framework formed by the fixed jaws 102a and 102b and the cross bar connections creates a stable platform that transfers operator input efficiently to the hardware engagement points, reducing the physical effort required for bolt removal operations. The mechanical advantage provided by the tool structure enables effective removal of hardware that has been subjected to environmental corrosion or mechanical stress over extended periods.

The safety features incorporated into the tool design provide advantages over prior art approaches that may expose operators to injury risks during hardware removal procedures. The secure clamping mechanism eliminates the need for operators to position their hands near moving or potentially failing hardware components, reducing the risk of injury from sudden bolt failure or tool slippage. The controlled engagement provided by the tension mechanism prevents sudden release of stored energy that could occur with impact tools or when hardware suddenly breaks free during removal operations.

The portable and self-contained design of the tool provides operational advantages in field conditions where access to power tools or specialized equipment may be limited. The manual operation of the tension mechanism eliminates the need for compressed air, hydraulic systems, or electrical power, enabling the tool to be deployed in remote locations or emergency situations where powered equipment may not be available. The compact configuration facilitates transportation to work sites and storage in maintenance vehicles, providing convenience advantages over larger or more complex hardware removal systems.

One or more different inventions may be described in the present application. Further, for one or more of the invention(s) described herein, numerous embodiments may be described in this patent application and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A guardrail hardware removal tool comprising:
a frame having a fixed jaws configured to engage a guardrail beam, the fixed jaws including an upper hook and a lower hook configured to secure to edges of the guardrail beam;
a movable jaws carried by the frame and positioned to move relative to the fixed jaws;
a contact pads carried by the movable jaws and configured to engage guardrail hardware extending from the guardrail beam; and
a tension mechanism operatively connected to the movable jaws and configured to control positioning of the movable jaws relative to the fixed jaws, wherein the contact pads apply pressure to the guardrail hardware to prevent rotation during hardware removal operations.

2. The guardrail hardware removal tool of claim 1, wherein the frame comprises steel plates arranged to accept a W-shape guardrail beam, and wherein each steel plate makes contact with a surface of the W-shape guardrail beam.

3. The guardrail hardware removal tool of claim 1, wherein the movable jaws comprise a first movable jaw and a second movable jaw, and further comprising a jaw tension cross bar extending between the first movable jaw and the second movable jaw to coordinate movement of the movable jaws.

4. The guardrail hardware removal tool of claim 1, wherein the tension mechanism comprises a tension bar head connected to the jaw tension cross bar and a tension bar extending through the tension bar head, wherein rotation of the tension bar controls positioning of the movable jaws.

5. The guardrail hardware removal tool of claim 4, wherein the tension bar head comprises a shaped interface configured for engagement with a tool selected from the group consisting of wrenches, socket drivers, and screwdrivers.

6. The guardrail hardware removal tool of claim 1, wherein the contact pads comprise upper contact pads and lower contact pads positioned to engage with splice bolts extending from the guardrail beam, and further comprising contact jaw pivots connecting the contact pads to the movable jaws to allow the contact pads to adjust orientation when engaging the guardrail beam.

7. The guardrail hardware removal tool of claim 1, wherein the movable jaws are guided by movable jaw bars extending through movable jaw slots formed in the movable jaws, the movable jaw bars and movable jaw slots defining a controlled path for movement of the movable jaws relative to the fixed jaws.

8. A guardrail bolt stabilization apparatus facilitating guardrail removal comprising:
a clamping frame configured to mount on a W-shaped guardrail beam;
a plurality of contact elements carried by the clamping frame and positioned to engage multiple surfaces of the W-shaped guardrail beam;
an adjustment mechanism operatively connected to the contact elements and configured to control engagement force applied by the contact elements to guardrail bolts; and
a hook elements extending from the clamping frame and configured to secure the apparatus to the guardrail beam during operation.

9. The guardrail bolt stabilization apparatus of claim 8, wherein the clamping frame comprises fixed jaws connected by cross bars, and wherein the fixed jaws are configured to provide structural support for the contact elements during operation.

10. The guardrail bolt stabilization apparatus of claim 1, wherein the hook elements comprise an upper hook and a lower hook extending from the fixed jaws, the upper hook configured to engage an upper edge of the W-shaped guardrail beam and the lower hook configured to engage a lower edge of the W-shaped guardrail beam.

11. The guardrail bolt stabilization apparatus of claim 8, wherein the plurality of contact elements comprises upper contact pads and lower contact pads positioned to engage splice bolts extending from the W-shaped guardrail beam, and further comprising contact jaw pivots connecting the contact elements to the clamping frame to allow the contact elements to adjust orientation when engaging the guardrail beam.

12. The guardrail bolt stabilization apparatus of claim 8, wherein the contact elements are carried by movable jaw assemblies that are guided by movable jaw bars extending through movable jaw slots, the movable jaw bars and movable jaw slots defining a controlled path for movement of the contact elements relative to the clamping frame.

13. The guardrail bolt stabilization apparatus of claim 8, wherein the adjustment mechanism comprises a tension bar extending through a tension bar head, wherein rotation of the tension bar controls engagement force applied by the contact elements to the guardrail bolts.

14. The guardrail bolt stabilization apparatus of claim 13, wherein the tension bar head comprises a shaped interface selected from the group consisting of hexagonal, square, slotted, cross-slotted, starred, and keyed configurations for engagement with corresponding tools.

15. An apparatus for removing seized guardrail hardware comprising:
a structural framework including a fixed jaw assembly and a movable jaw assembly;
attachment hooks carried by the structural framework and configured to engage upper and lower edges of a guardrail structure;
pressure-applying elements positioned between the first jaw assembly and the second jaw assembly and configured to contact bolt heads extending from the guardrail structure; and
an actuating system configured to move the pressure-applying elements toward the guardrail structure to immobilize the bolt heads while allowing access to corresponding nuts on an opposite side of the guardrail structure.

16. The apparatus of claim 15, wherein the structural framework includes a cross bars connecting a plurality of fixed jaws, and wherein the second jaw assembly is a movable jaw assembly positioned to move relative to the fixed jaw assembly.

17. The apparatus of claim 15, wherein the attachment hooks comprise an upper hook and a lower hook extending from the fixed jaws, the upper hook configured to engage an upper edge of the guardrail structure and the lower hook configured to engage a lower edge of the guardrail structure.

18. The apparatus of claim 15, wherein the pressure-applying elements comprise contact pads configured to engage splice bolts extending from the guardrail structure, and further comprising pivot connections connecting the contact pads to the first jaw assembly and the second jaw assembly to allow the contact pads to adjust orientation when engaging the guardrail structure.

19. The apparatus of claim 15, wherein the first jaw assembly or the second jaw assembly is guided by guide bars extending through guide slots formed in the first jaw assembly or the second jaw assembly, the guide bars and guide slots defining a controlled path for movement of the pressure-applying elements relative to the structural framework.

20. The apparatus of claim 15, wherein the actuating system comprises a threaded adjustment mechanism including a tension bar extending through a tension bar head, wherein rotation of the tension bar controls movement of the second jaw assembly along the controlled path defined by the guide bars and guide slots.
